(19) United States
(12) Patent Application Publication
(10) Pub. No.: US 2021/0300414 A1
(43) Pub. Date: Sep. 30, 2021

(54) VEHICLE CONTROL METHOD, VEHICLE CONTROL DEVICE, AND STORAGE MEDIUM

(71) Applicant: HONDA MOTOR CO., LTD., Tokyo (JP)

(72) Inventors: Yuji Yasui, Wako-shi (JP); Tsubasa Shibauchi, Tokyo (JP)

(21) Appl. No.: 17/210,565

(22) Filed: Mar. 24, 2021

(30) Foreign Application Priority Data
Mar. 31, 2020 (JP) 2020-063515

(51) Int. Cl. B60W 60/00; B60W 40/105; B60W 40/072; G06N 5/00; B60W 30/095; G06K 9/00

(52) U.S. Cl. CPC B60W 60/0011; B60W 40/105; B60W 40/072; B60W 2554/80; B60W 60/0027; B60W 30/0956; G06K 9/00798; G06N 5/003

(57) ABSTRACT

A vehicle control method includes recognizing an environment around a vehicle, determining a degree of difficulty of a recognition of the environment on the basis of the environment, generating a plurality of target trajectories along which the vehicle is to travel on the basis of the environment and selecting one target trajectory from the generated plurality of target trajectories in accordance with the determined degree of difficulty, and automatically controlling the driving of the vehicle on the basis of the selected target trajectory.

### CROSS-REFERENCE TO RELATED APPLICATION

Priority is claimed on Japanese Patent Application No. 2020-063515, filed Mar. 31, 2020, the content of which is incorporated herein by reference.

### BACKGROUND OF THE INVENTION

### Field of the Invention

The present invention relates to a vehicle control method, a vehicle control device, and a storage medium.

### Description of Related Art

A technology of selecting any one model from a plurality of models which define a correspondence between a relative position between a host vehicle and a moving body around the host vehicle and a driving operation of a driver, according to a direction of advance or the like of a pedestrian, is known (for example, PCT International Publication No. 2013/042260).

### SUMMARY OF THE INVENTION

However, in the related art, regarding smoothly controlling driving of a vehicle in accordance with a degree of difficulty when recognizing the environment around the vehicle was not considered.

An aspect of the present invention is directed to providing a vehicle control method, a vehicle control device, and a storage medium that are capable of smoothly controlling driving of a vehicle in accordance with a degree of difficulty when recognizing the environment around the vehicle.

A vehicle control method, a vehicle control device, and a storage medium according to the present invention employ the following configurations.

A first aspect of the present invention is a vehicle control method including: recognizing an environment around the vehicle; determining a degree of difficulty of a recognition of the environment on the basis of the recognized environment; generating a plurality of target trajectories along which the vehicle is to travel on the basis of the recognized environment and selecting one target trajectory from the generated plurality of target trajectories in accordance with the determined degree of difficulty; and automatically controlling driving of the vehicle on the basis of the selected target trajectory.

According to a second aspect, in the first aspect, the vehicle control method may further include calculating a region of risk distributed around an object as a part of the environment, and inputting the region to each of a plurality of models that outputs the target trajectory when the region is input, and generating the plurality of target trajectories on the basis of an output result of each of the plurality of models into which the region was input.

According to a third aspect, in the second aspect, the plurality of models may include a first model which is rule-based model or model-based model, and a second model which is a machine learning based model.

According to a fourth aspect, in the third aspect, among a first target trajectory that is the target trajectory output by the first model and a second target trajectory that is the target trajectory output by the second model, the second target trajectory is selected in a case the degree of difficulty exceeds a predetermined value.

According to a fifth aspect, in any one of the first to fourth aspects, the vehicle control method may further include sensing surroundings of the vehicle, and inputting a sensing result of surroundings of a certain target vehicle with respect to a machine learning-based third model when the sensing result is input, and recognizing the environment around the vehicle on the basis of an output result of the third model to which the sensing result was input, the machine learning-based third model being learned so as to output information showing an environment around the target vehicle.

According to a sixth aspect, in the fifth aspect, the vehicle control method may further include determining the degree of difficulty according to a learning quantity of the third model.

According to a seventh aspect, in the sixth aspect, the third model may be learned to output information showing that the environment around the target vehicle is in a certain first environment when a sensing result of surroundings of the target vehicle under the first environment is input, and is learned to output information showing that the environment around the target vehicle is in a second environment different from the first environment when a sensing result of surroundings of the target vehicle under the second environment is input, and the vehicle control method may further include determining the degree of difficulty according to the learning quantity of the third model learned under the first environment when the first environment is recognized by the recognition part, and determining the degree of difficulty according to the learning quantity of the third model learned under the second environment when the second environment is recognized.

According to an eighth aspect, in the sixth or seventh aspect, the vehicle control method may further include decreasing the degree of difficulty as the learning quantity of the third model is larger, and increasing the degree of difficulty as the learning quantity of the third model is smaller.

According to a ninth aspect, in any one of the first to eighth aspects, the vehicle control method may further include determining the degree of difficulty according to a number of moving body recognized as a part of the environment.

According to a tenth aspect, in the ninth aspect, the vehicle control method may further include decreasing the degree of difficulty as the number of the moving body is smaller, and increasing the degree of difficulty as the number of the moving body is larger.

According to an eleventh aspect, in any one of the first to tenth aspects, determining the degree of difficulty according to a curvature of a road recognized as a part of the environment.

According to a twelfth aspect, in the eleventh aspect, the vehicle control method may further include decreasing the degree of difficulty as the curvature of the road is smaller, and increasing the degree of difficulty as the curvature of the road is larger.

According to a thirteenth aspect, in any one of the first to twelfth aspects, the vehicle control method may further include determining the degree of difficulty according to a relative speed difference between an average speed of a plurality of moving bodies recognized as a part of the environment and a speed of the vehicle.

According to a fourteenth aspect, in the thirteenth aspect, the vehicle control method may further include decreasing the degree of difficulty as the speed difference is smaller, and increasing the degree of difficulty as the speed difference is larger.

According to a fifteenth aspect, in any one of the first to fourteenth aspects, the vehicle control method may further include determining the degree of difficulty according to a speed of the vehicle.

According to a sixteenth aspect, in the fifteenth aspect, the vehicle control method may further include decreasing the degree of difficulty as the speed is increased, and increasing the degree of difficulty as the speed is decreased.

According to a seventeenth aspect, in any one of the first to sixteenth aspect, the vehicle control method may further include determining whether the vehicle is in an emergency state on the basis of a relative distance and a relative speed between a moving body, which is recognized as a part of the environment by the recognition part, and the vehicle, selecting the first target trajectory regardless of the degree of difficulty in a case the vehicle is determined to be in the emergency state, and controlling the driving of the vehicle such that the moving body is avoided on the basis of the selected first target trajectory.

An eighteenth aspect is a vehicle control device comprising: a recognition part configured to recognize an environment around a vehicle; a determining part configured to determine a degree of difficulty of a recognition of the environment on the basis of the environment recognized by the recognition part; a generating part configured to generate a plurality of target trajectories along which the vehicle is to travel on the basis of the environment recognized by the recognition part and to select one target trajectory from the generated plurality of target trajectories in accordance with the degree of difficulty determined by the determining part; and a driving controller configured to automatically control driving of the vehicle on the basis of the target trajectory selected by the generating part.

A nineteenth aspect is a computer-readable storage medium on which a program is stored to execute a computer mounted on a vehicle to: recognize an environment around the vehicle; determine a degree of difficulty of a recognition of the environment on the basis of the recognized environment; generate a plurality of target trajectories along which the vehicle is to travel on the basis of the recognized environment and select one target trajectory from the generated plurality of target trajectories in accordance with the determined degree of difficulty; and automatically control driving of the vehicle on the basis of the selected target trajectory.

According to any one of the above-mentioned aspects, it is possible to smoothly control driving of a vehicle in accordance with a degree of difficulty when recognizing an environment around the vehicle.

### BRIEF DESCRIPTION OF THE DRAWINGS

FIG. 1 is a configuration view of a vehicle system using a vehicle control device according to a first embodiment.

FIG. 2 is a functional configuration view of a first controller, a second controller, and a storage according to the first embodiment.

FIG. 3 is a view for explaining a risk region.

FIG. 4 is a view showing a variation in risk potential in a Y direction at a certain coordinate x1.

FIG. 5 is a view showing a variation in risk potential in a Y direction at a certain coordinate x2.

FIG. 6 is a view showing a variation in risk potential in a Y direction at a certain coordinate x3.

FIG. 7 is a view showing a variation in risk potential in an X direction at a certain coordinate x4.

FIG. 8 is a view showing a risk region determined by a risk potential.

FIG. 9 is a view schematically showing a generating method of a target trajectory.

FIG. 10 is a view showing an example of a target trajectory output from a certain DNN model.

FIG. 11 is a flowchart showing an example of a series of processing flows by an automatic driving control device according to the first embodiment.

FIG. 12 is a view showing an example of learning quantity data.

FIG. 13 is a view showing an example of a situation at a first time period.

FIG. 14 is a view showing an example of a situation in a second time period.

FIG. 15 is a view showing an example of a situation that a host vehicle may encounter.

FIG. 16 is a view showing another example of a situation that a host vehicle may encounter.

FIG. 17 is a view showing an example of a hardware configuration of an automatic driving control device of the embodiment.

### DETAILED DESCRIPTION OF THE INVENTION

Hereinafter, embodiments of a vehicle control device, a vehicle control method, and a program of the present invention will be described with reference to the accompanying drawings. The vehicle control device of the embodiment is applied to, for example, an automatic traveling vehicle. Automatic traveling is, for example, controlling driving of the vehicle by controlling one or both of a speed or steering of the vehicle. The above-mentioned driving control of the vehicle includes various types of driving control, for example, an adaptive cruise control system (ACC), a traffic jam pilot (TJP), auto lane changing (ALC), a collision mitigation brake system (CMBS) or a lane keeping assistance system (LKAS). Driving of the automatic traveling vehicle may be controlled by manual driving of an occupant (a driver).

### First Embodiment

### [Entire Configuration]

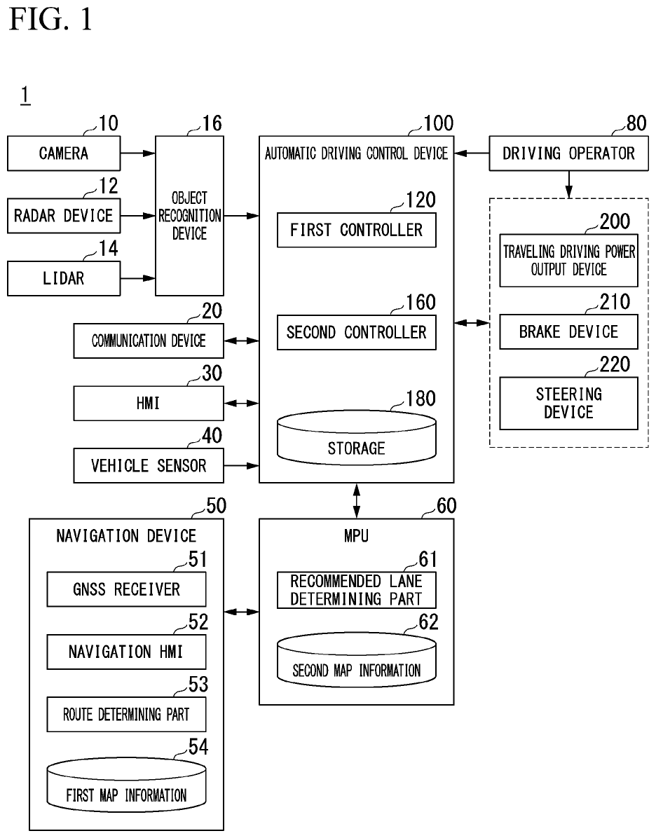

FIG. 1 is a configuration view of a vehicle system 1 using a vehicle control device according to a first embodiment. A vehicle on which the vehicle system 1 is mounted (hereinafter, referred to as a host vehicle M) is, for example, a two-wheeled, three-wheeled, or four-wheeled vehicle, and a driving source thereof is an internal combustion engine such as a diesel engine, a gasoline engine, or the like, an electric motor, or a combination of these. The electric motor is operated using an output generated by a generator connected to the internal combustion engine, or discharged energy of a secondary battery or a fuel cell.

The vehicle system 1 includes, for example, a camera 10, a radar device 12, light detection and ranging (LIDAR) 14, an object recognition device 16, a communication device 20, a human machine interface (HMI) 30, a vehicle sensor 40, a navigation device 50, a map positioning unit (MPU) 60, a driving operator 80, an automatic driving control device 100, a traveling driving power output device 200, a brake device 210, and a steering device 220. These devices or instruments are connected to each other by a multiple communication line such as a controller area network (CAN) communication line or the like, a serial communication line, a wireless communication network, or the like. The configuration shown in FIG. 1 is merely an example, a part of the configuration may be omitted, and another configuration may be added. The automatic driving control device 100 is an example of “a vehicle control device.”

The camera 10 is, for example, a digital camera using a solid-state image sensing device such as a charge coupled device (CCD), a complementary metal oxide semiconductor (CMOS), or the like. The camera 10 is attached to an arbitrary place of the host vehicle M. For example, when a side in front of the host vehicle M is imaged, the camera 10 is attached to an upper section of a front windshield, a rear surface of a rearview mirror, or the like. In addition, when a side behind the host vehicle M is imaged, the camera 10 is attached to an upper section of a rear windshield, or the like. In addition, when the right side or the left side of the host vehicle M is imaged, the camera 10 is attached to a right side surface or a left side surface of a vehicle body or a door mirror. The camera 10 images surroundings of the host vehicle M, for example, periodically and repeatedly. The camera 10 may be a stereo camera. The camera 10 is an example of “a sensor.”

The radar device 12 radiates radio waves such as millimeter waves or the like to surroundings of the host vehicle M, and simultaneously, detects the radio waves (reflected waves) reflected by the object to detect a position (a distance and an azimuth) of at least the object. The radar device 12 is attached to an arbitrary place of the host vehicle M. The radar device 12 may detect a position and a speed of the object using a frequency modulated continuous wave (FM-CW) method. The radar device 12 is another example of “a sensor.”

The LIDAR 14 radiates light to surroundings of the host vehicle M, and measures the scattered light of the radiated light. The LIDAR 14 detects a distance to a target on the basis of a time from emission to reception of light. The radiated light is, for example, a pulse-shaped laser beam. The LIDAR 14 is attached to an arbitrary place of the host vehicle M. The LIDAR 14 is another example of “a sensor.”

The object recognition device 16 recognizes a position, a type, a speed, or the like, of the object by performing sensor fusion processing with respect to the detection result by some or all of the camera 10, the radar device 12, and the LIDAR 14. The object recognition device 16 outputs the recognized result to the automatic driving control device 100. In addition, the object recognition device 16 may output the detection results of the camera 10, the radar device 12 and the LIDAR 14 directly to the automatic driving control device 100. In this case, the object recognition device 16 may be omitted from the vehicle system 1.

The communication device 20 uses, for example, a cellular network, a Wi-Fi network, a Bluetooth (registered trademark), dedicated short range communication (DSRC), or the like, comes in communication with another vehicle present in the vicinity of the host vehicle M, or comes in communication with various server devices via a radio base station.

The HMI 30 receives an input operation by an occupant in the host vehicle M while providing various types of information to the occupant (including a driver). The HMI 30 includes, for example, a display, a speaker, a buzzer, a touch panel, a microphone, a switch, a key, or the like.

The vehicle sensor 40 includes a vehicle speed sensor configured to detect a speed of the host vehicle M, an acceleration sensor configured to detect an acceleration, a yaw rate sensor configured to detect an angular speed around a vertical axis, and an azimuth sensor configured to detect an orientation of the host vehicle M.

The navigation device 50 includes, for example, a global navigation satellite system (GNSS) receiver 51, a navigation HMI 52, and a route determining part 53. The navigation device 50 holds first map information 54 in a storage device such as a hard disk drive (HDD) a flash memory, or the like.

The GNSS receiver 51 specifies a position of the host vehicle M on the basis of a signal received from the GNSS satellite. The position of the host vehicle M may be specified or complemented by an inertial navigation system (INS) that uses output of the vehicle sensor 40.

The navigation HMI 52 includes a display device, a speaker, a touch panel, a key, and the like. The navigation HMI 52 may be partially or entirely shared with the HMI 30 described above. For example, the occupant may input a destination of the host vehicle M to the navigation HMI 52 instead of (or in addition to) inputting the destination of the host vehicle M to the HMI 30.

The route determining part 53 determines, for example, a route (hereinafter, a route on a map) from a position of the host vehicle M specified by the GNSS receiver 51 (or an input arbitrary position) to a destination input by an occupant using the HMI 30 or the navigation HMI 52 with reference to the first map information 54.

The first map information 54 is, for example, information in which a road shape is expressed by a link showing a road and a node connected by the link. The first map information 54 may include a curvature of a road, point of interest (POI) information, or the like. The route on a map is output to the MPU 60.

The navigation device 50 may perform route guidance using the navigation HMI 52 on the basis of the route on a map. The navigation device 50 may be realized by, for example, a function of a terminal device such as a smart phone, a tablet terminal, or the like, held by the occupant. The navigation device 50 may transmit the current position and the destination to the navigation server via the communication device 20, and acquire the same route as the route on a map from the navigation server.

The MPU 60 includes, for example, a recommended lane determining part 61, and holds second map information 62 in a storage device such as an HDD, a flash memory, or the like. The recommended lane determining part 61 divides the route on a map provided from the navigation device 50 into a plurality of blocks (for example, divided at each 100 [m] in an advance direction of the vehicle), and determines a recommended lane at each block with reference to the second map information 62. The recommended lane determining part 61 performs determination of which lane the vehicle travels from the left. The recommended lane determining part 61 determines a recommended lane such that the host vehicle M can travel a reasonable route so as to reach to a branch destination when a diverging place is present on the route on a map.

The second map information 62 is map information that has a higher precision than the first map information 54. The second map information 62 includes, for example, information of a center of a lane, information of a boundary of a lane, or the like. In addition, the second map information 62 may include road information, traffic regulation information, address information (address/zip code), facility information, telephone number information, and the like. The second map information 62 may be updated at any time by bring the communication device 20 in communication with another device.

The driving operator 80 includes, for example, an acceleration pedal, a brake pedal, a shift lever, a steering wheel, a modified steer, a joystick, and other operators. A sensor configured to detect an operation amount or existence of an operation is attached to the driving operator 80, and the detection result is output to some or all of the automatic driving control device 100, the traveling driving power output device 200, the brake device 210, and the steering device 220.

The automatic driving control device 100 includes, for example, a first controller 120, a second controller 160, and a storage 180. The first controller 120 and the second controller 160 are realized by executing a program (software) using a hardware processor such as a central processing unit (CPU), a graphics processing unit (GPU) or the like. Some or all of these components may be realized by hardware (a circuit part; including a circuitry) such as large scale integration (LSI), an application specific integrated circuit (ASIC), a field-programmable gate array (FPGA), or the like, or may be realized by cooperation of software and hardware. The program may be previously stored in a storage device (a storage device including a non-transient storage medium) such as an HDD, a flash memory, or the like, of the automatic driving control device 100, stored in a detachable storage medium such as a DVD, a CD-ROM, or the like, or installed on an HDD or a flash memory of the automatic driving control device 100 by mounting a storage medium (a non-transient storage medium) on a drive device.

The storage 180 is realized by the above-mentioned various types of storage devices. The storage 180 is realized by, for example, an HDD, a flash memory, an electrically erasable programmable read only memory (EEPROM), a read only memory (ROM), a random access memory (RAM), or the like. Environment recognition model data 182, trajectory generating model data 184, learning quantity data 186, or the like, is stored in the storage 180, for example, in addition to the program read and executed by the processor. The environment recognition model data 182, the trajectory generating model data 184, or the learning quantity data 186 will be described below in detail.

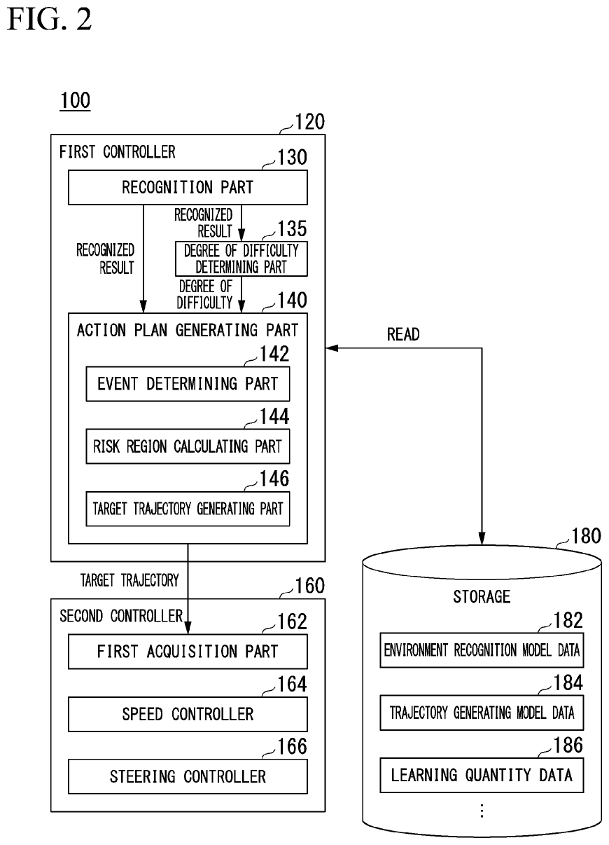

FIG. 2 is a functional configuration view of the first controller 120, the second controller 160 and the storage 180 according to the embodiment. The first controller 120 includes, for example, a recognition part 130, a difficulty determining part 135 and an action plan generating part 140.

The first controller 120 realizes, for example, both of a function of artificial intelligence (AI) and a function of a previously provided model at the same time. For example, a function of “recognizing a crossroad” is executed parallel to recognition of a crossroad through deep learning or the like and recognition based on a previously provided condition (a signal that enables matching of patterns, road markings, or the like), and may be realized by scoring and comprehensively evaluating them. Accordingly, reliability of automatic driving is guaranteed.

The recognition part 130 reads the environment recognition model data 182 from the storage 180, and recognizes an environment around the host vehicle M using a model defined by the data.

The environment recognition model data 182 is information (a program or a data structure) defined by an environment recognition model MDL1 used to recognize an environment. The environment recognition model MDL1 is a deep neural network (DNN(s)) learned to output a type, a state, or the like of an object as a part of the environment when sensing results of various sensors such as the camera 10, the radar device 12, and the LIDAR 14 are directly input or indirectly input via the object recognition device 16. Specifically, the environment recognition model MDL1 may be a convolutional neural network (CNN), a reccurent neural network (RNN), or a combination of these. The environment recognition model MDL1 is an example of “a third model.”

The environment recognition model data 182 includes, for example, various types of information such as coupling information showing how units included in a plurality of layers constituting the DNN are coupled to each other, a coupling coefficient applied to the data input and output between the coupled units, or the like.

The coupling information includes, for example, information that designates the number of units included in each layer, a type of a unit which is a coupling mate member of each of the units, or the like, and information of an activation function of each unit, a gate provided between the units of the hidden layer, or the like. The activation function may be, for example, a normalized linear function (an ReLU function), or may be a Sigmoid function, a step function, or the other functions. The gate selectively passes or weights the data transmitted between the units, for example, according to a value (for example, 1 or 0) returned by the activation function. The coupling coefficient includes, for example, a weight coefficient given to the output data when the data is output from a unit of a certain layer to a unit of a deeper layer in the hidden layer of the neural network. In addition, the coupling coefficient may include a bias element peculiar to each layer.

The environment recognition model MDL1 is sufficiently learned on the basis of, for example, instructor data. The instructor data is, for example, a data set in which a type and a state of the object present around a certain target vehicle is associated with a sensing result of a sensor attached to the target vehicle as an instructor label (also referred to as a target). The target vehicle may be the host vehicle M, or may be a vehicle other than the host vehicle M. That is, the instructor data is a data set in which a sensing result of the sensor that is input data and a type and a state of the object that are output data are combined.

The type of the object output by the environment recognition model MDL1 includes, for example, a bicycle, an motorcycle, a four-wheeled automobile, a pedestrian, road signs, road markings, road marking lines, electric poles, a guardrail, falling objects, or the like. The state of the object output by the environment recognition model MDL1 includes a position, a speed, an acceleration, a jerk, or the like. The position of the object may be, for example, a position on relative coordinates using a representative point (a center of gravity, a driving axial center, or the like) of the host vehicle M as the origin (i.e., a relative position with respect to the host vehicle M). The position of the object may be displayed at a representative point such as a center of gravity, a corner, or the like, of the object, or may be displayed as an expressed region.

For example, in the recognition part 130, when an image of the camera 10 is input to the environment recognition model MDL1, the environment recognition model MDL1 outputs a position and a type of a pattern of the road marking line around the host vehicle M. In this case, the recognition part 130 recognizes a space between road marking lines as a host lane or a neighboring lane by comparing a pattern (for example, arrangement of solid lines and broken lines) of road marking lines output by the environment recognition model MLD1 and a pattern of the road marking line obtained from the second map information 62.

In addition, the recognition part 130 may recognize a host lane or a neighboring lane by recognizing traveling lane boundaries (road boundaries) including road marking lines, road shoulders, curbstones, median strips, guardrails, and the like, while not being limited to road marking lines. In the recognition, the position of the host vehicle M acquired from the navigation device 50 or a processing result by the INS may be added. In addition, the recognition part 130 may recognize a temporary stop line, an obstacle, a red signal, a tollgate, and other road events.

The recognition part 130 recognizes a relative position or an attitude of the host vehicle M with respect to the host lane when the host lane is recognized. The recognition part 130 may recognize a separation from a lane center of a reference point of the host vehicle M and an angle of the host vehicle M with respect to a line that connects a lane center in an advance direction as a relative position and an attitude of the host vehicle M with respect to the host lane. Instead of this, the recognition part 130 may recognize a position or the like of a reference point of the host vehicle M with respect to any side end portion (a road marking line or a road boundary) of the host lane as a relative position of the host vehicle M with respect to the host lane.

The difficulty determining part 135 determines a degree of difficulty when an environment is recognized (hereinafter, referred to as a degree of difficulty of environment recognition) on the basis of the environment around the host vehicle M recognized by the recognition part 130. A specific determining method of the degree of difficulty of environment recognition will be described below.

The action plan generating part 140 includes, for example, an event determining part 142, a risk region calculating part 144 and a target trajectory generating part 146.

The event determining part 142 determines a traveling aspect of automatic traveling when the host vehicle M is automatically traveling on a route in which a recommended lane is determined. Hereinafter, information that defines a traveling aspect of the automatic traveling will be described while being referred to as an event.

The event includes, for example, a fixed speed traveling event, a following traveling event, a lane change event, a diverging event, a merging event, a take-over event, or the like. The fixed speed traveling event is a traveling aspect of causing the host vehicle M to travel along the same lane at a fixed speed. The following traveling event is a traveling aspect of causing the host vehicle M to follow another vehicle present within a predetermined distance in front of the host vehicle M on the host lane (for example, within 100 [m]) and closest to the host vehicle M (hereinafter, referred to as a preceding vehicle).

“Following” may be, for example, a traveling aspect of maintaining a constant inter-vehicle distance (a relative distance) between the host vehicle M and a preceding vehicle, or may be a traveling aspect of causing the host vehicle M to travel along a center of the host lane, in addition to maintaining the constant inter-vehicle distance between the host vehicle M and the preceding vehicle.

The lane change event is a traveling aspect of causing the host vehicle M to change lanes from the host lane to a neighboring lane. The diverging event is a traveling aspect of causing the host vehicle M to move to a lane on the side of the destination at a diverging point of the road. The merging event is a traveling aspect of causing the host vehicle M to join a main line at a merging point. The take-over event is a traveling aspect of terminating automatic traveling and switching the automatic driving to manual driving.

In addition, the event may include, for example, an overtaking event, an avoiding event, or the like. The overtaking event is a traveling aspect of causing the host vehicle M to change the lane to a neighboring lane at once, overtake the preceding vehicle in the neighboring lane and change the lane to the original lane again. The avoiding event is a traveling aspect of causing the host vehicle M to perform at least one of braking and steering to avoid an obstacle present in front of the host vehicle M.

In addition, for example, the event determining part 142 may change the event already determined with respect to the current section to another event, or determine a new event with respect to the current section according to a situation of the surroundings recognized by the recognition part 130 when the host vehicle M is traveling.

The risk region calculating part 144 calculates a risk region potentially distributed or present around the object recognized as a part of the environment by the recognition part 130 (hereinafter, referred to as a risk region RA). The risk is, for example, a risk that an object exerts an influence on the host vehicle M. More specifically, the risk may be a risk of the host vehicle M being caused to brake suddenly because a preceding vehicle has suddenly slowed down or another vehicle has cut in front of the host vehicle M from a neighboring lane, or may be a risk of the host vehicle M being forced to be steered suddenly because a pedestrian or a bicycle has entered the roadway. In addition, the risk may be a risk that the host vehicle M will exert an influence on the object. Hereinafter, the level of such risk is treated as a quantitative index value, and the index value which will be described below is referred to as “a risk potential p.”

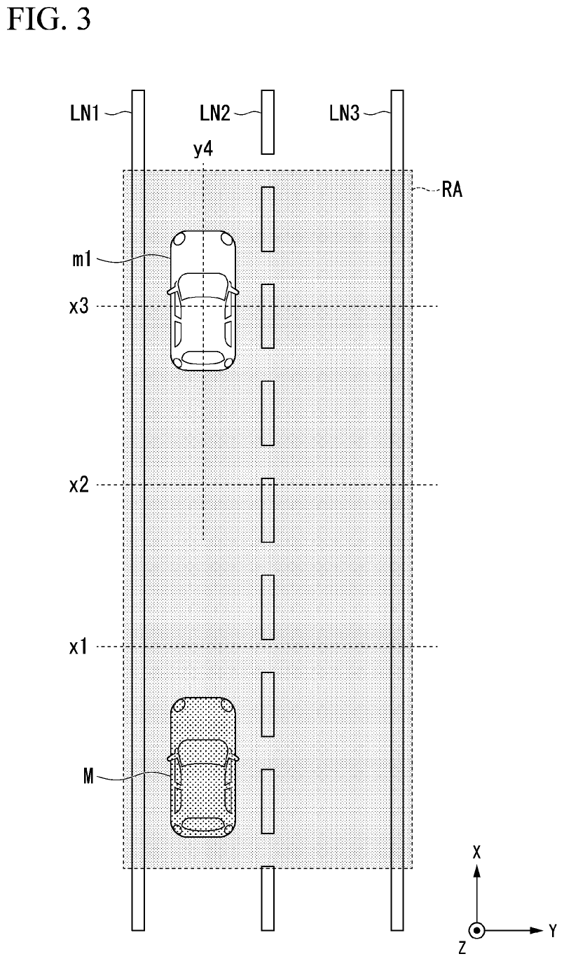

FIG. 3 is a view for explaining the risk region RA. LN1 in the drawing designates a road marking line that partitions off the host lane on one side, and LN2 designates the other road marking line that partitions off the host lane on the other side and a road marking line that partitions off a neighboring lane on one side. LN3 designates the other road marking line that divides the neighboring lane. In the plurality of road marking lines, LN1 and LN3 designate roadway edge markings, and LN2 designates a center line that vehicles are allowed to pass beyond when overtaking. In addition, in the example shown, a preceding vehicle m1 is present in front of the host vehicle M on the host lane. X in the drawings designates a direction in which the vehicle is advancing, Y designates a widthwise direction of the vehicle, and Z designates a vertical direction.

In the case of the situation shown, in the risk region RA, the risk region calculating part 144 increases the risk potential p in a region close to the roadway edge markings LN1 and LN3, and decreases the risk potential p in a region distant from the roadway edge markings LN1 and LN3.

In addition, in the risk region RA, the risk region calculating part 144 increases the risk potential p as it approaches the region close to the center line LN2 and decreases the risk potential p as it approaches the region far from the center line LN2. Since the center line LN2 is different from the roadway edge markings LN1 and LN3 and the vehicle is allowed to deviate from the center line LN2, the risk region calculating part 144 causes the risk potential p with respect to the center line LN2 to be lower than the risk potential p with respect to the roadway edge markings LN1 and LN3.

In addition, in the risk region RA, the risk region calculating part 144 increases the risk potential p as it approaches a region close to the preceding vehicle m1 that is one of an object, and decreases the risk potential p as it approaches a region far from the preceding vehicle m1. That is, in the risk region RA, the risk region calculating part 144 may increase the risk potential p as a relative distance between the host vehicle M and the preceding vehicle m1 becomes shorter, and may decrease the risk potential p as the relative distance between the host vehicle M and the preceding vehicle m1 becomes longer. Here, the risk region calculating part 144 may increase the risk potential p as an absolute speed or an absolute acceleration of the preceding vehicle m1 is increased. In addition, the risk potential p may be appropriately determined according to a relative speed or a relative acceleration between the host vehicle M and the preceding vehicle m1, a time to collision (TTC), or the like, instead of or in addition to the absolute speed or the absolute acceleration of the preceding vehicle m1.

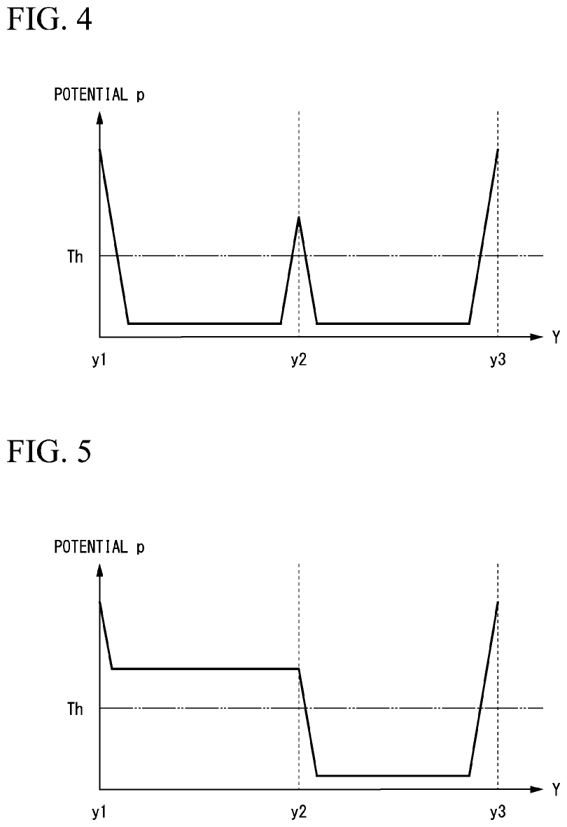

FIG. 4 is a view showing a variation in the risk potential p in the Y direction at a certain coordinate x1. Here, y1 in the drawing designates a position (coordinate) of the roadway edge marking LN1 in the Y direction, y2 designates a position (coordinate) of the center line LN2 in the Y direction, and y3 designates a position (coordinate) of the roadway edge marking LN3 in the Y direction.

As shown, the risk potential p is highest in the vicinity of the coordinates (x1, y1) at which the roadway edge marking LN1 is present or in the vicinity of the coordinates (x1, y3) at which the roadway edge marking LN3 is present, and the risk potential p is the second highest in the vicinity of the coordinates (x1, y2) at which the center line LN2 is present after the coordinates (x1, y1) or (x1, y3). As described above, in a region in which the risk potential p is equal to or greater than a previously determined threshold Th, in order to prevent the vehicle from entering the region, the target trajectory TR is not generated.

FIG. 5 is a view showing a variation in the risk potential p in the Y direction at a certain coordinate x2. The coordinate x2 is closer to the preceding vehicle m1 than the coordinate x1 is. For this reason, although the preceding vehicle m1 is not present in the region between the coordinates (x2, y1) at which the roadway edge marking LN1 is present and the coordinates (x2, y2) at which the center line LN2 is present, a risk can be considered such as the sudden deceleration of the preceding vehicle m1 or the like. As a result, the risk potential p in the region between (x2, y1) and (x2, y2) tends to be higher than the risk potential p in the region between (x1, y1) and (x1, y2), for example, the threshold Th or more.

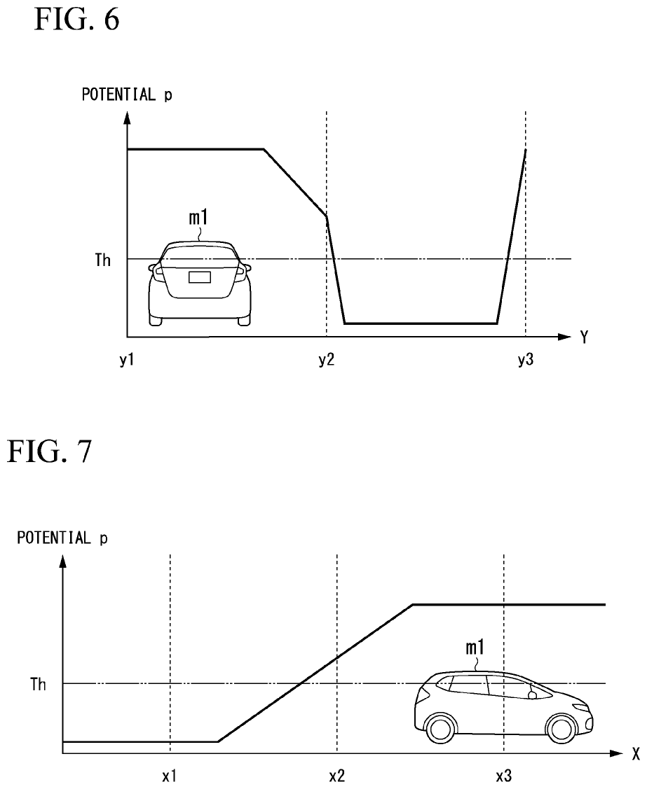

FIG. 6 is a view showing a variation in the risk potential p in the Y direction at a certain coordinate x3. The preceding vehicle m1 is present at the coordinate x3. For this reason, the risk potential p in the region between the coordinates (x3, y1) at which the roadway edge marking LN1 is present and the coordinates (x3, y2) at which the center line LN2 is present is higher than the risk potential p in the region between (x2, y1) and (x2, y2), and is equal to or greater than the threshold Th.

FIG. 7 is a view showing a variation in the risk potential p in the X direction at a certain coordinate y4. The coordinate y4 are intermediate coordinates between y1 and y2, and the preceding vehicle m1 is present at the coordinate y4. For this reason, the risk potential p is highest at the coordinates (x3, y4), the risk potential p at the coordinates (x2, y4) farther from the preceding vehicle m1 than the coordinates (x3, y4) is lower than the risk potential p at the coordinates (x3, y4), and the risk potential p at the coordinates (x1, y4) farther from the preceding vehicle m1 than the coordinates (x2, y4) is lower than the risk potential p at the coordinates (x2, y4).

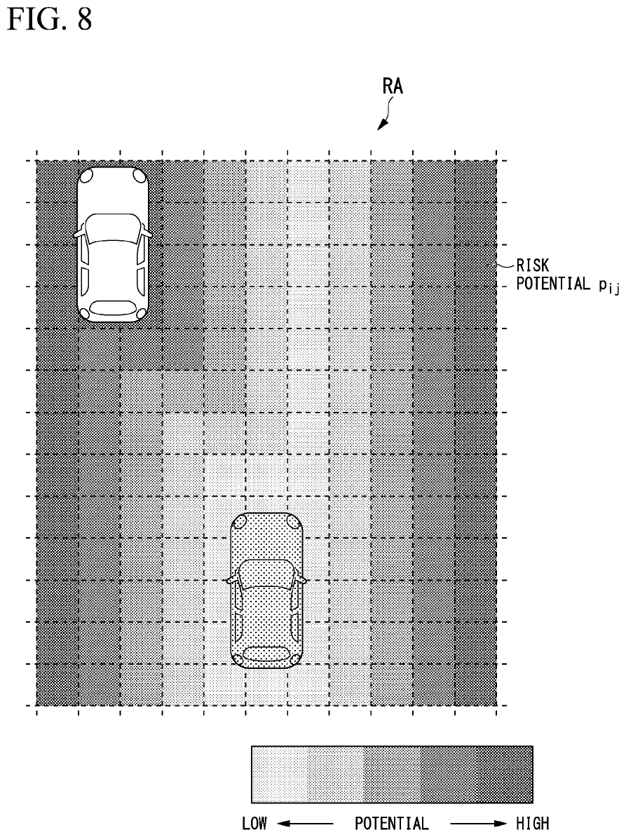

FIG. 8 is a view showing the risk region RA determined by the risk potential p. As shown, in the risk region calculating part 144, the risk region RA is divided into a plurality of mesh squares (also referred to as grid acquires), and the risk potential p is associated with each of the plurality of mesh squares. For example, the risk potential pᵢⱼ corresponds to the mesh square (xᵢ, yⱼ). That is, the risk region RA is expressed by a data structure referred to as a vector or a tensor.

The risk region calculating part 144 normalizes the risk potential p of each mesh when the risk potential p corresponds to each of the plurality of meshes.

For example, the risk region calculating part 144 may normalize the risk potential p such that the maximum value of the risk potential p is 1 and the minimum value is 0. Specifically, the risk region calculating part 144 selects the risk potential pₘₐₓ that becomes the maximum value and the risk potential pₘᵢₙ that becomes the minimum value among the risk potential p of all of the meshes included in the risk region RA. The risk region calculating part 144 selects one mesh (xᵢ, yⱼ) of interest from all of the meshes included in the risk region RA, subtracts the minimum risk potential pₘᵢₙ from the risk potential pᵢⱼ corresponding to the mesh (xᵢ, yⱼ), subtracts the minimum risk potential pₘᵢₙ from the maximum risk potential pₘₐₓ, and divides (pᵢⱼ−pₘᵢₙ) by (pₘₐₓ−Pₘᵢₙ). The risk region calculating part 144 repeats the above-mentioned processing while changing the mesh of interest. Accordingly, the risk region RA is normalized such that the maximum value of the risk potential p is 1 and the minimum value is 0.

In addition, the risk region calculating part 144 may calculate an average value μ and a standard deviation σ of the risk potential p of all the meshes included in the risk region RA, subtract the average value μ from the risk potential pᵢⱼ corresponding to the mesh (xᵢ, yⱼ), and divide (pᵢⱼ−μ) by the standard deviation σ. Accordingly, the risk region RA is normalized such that the maximum value of the risk potential p is 1 and the minimum value is 0.

In addition, the risk region calculating part 144 may normalize the risk potential p such that the maximum value of the risk potential p is an arbitrary M and the minimum value is an arbitrary m. Specifically, when (pᵢⱼ−pₘᵢₙ)/(pₘₐₓ−pₘᵢₙ) is A, the risk region calculating part 144 multiplies A by (M−m), and adds m to A (M−m). Accordingly, the risk region RA is normalized such that the maximum value of the risk potential p becomes M and the minimum value becomes m.

Returning to the description in FIG. 2, the target trajectory generating part 146 generates the future target trajectory TR to allow the host vehicle M to automatically travel (independently of an operation of the driver) in the traveling aspect defined by the event, such that the host vehicle M is able to travel in the recommended lane determined by the recommended lane determining part 61, and further, the host vehicle M is able to respond to the surrounding situation when traveling in the recommended lane. The target trajectory TR includes, for example, a position element that determines the position of the host vehicle M in the future, and a speed element that has determined the speed or the like of the host vehicle M in the future.

For example, the target trajectory generating part 146 determines a plurality of points (trajectory points) at which the host vehicle M should arrive in sequence as position elements of the target trajectory TR. The trajectory point is a point at which the host vehicle M should arrive after each of predetermined traveling distances (for example, about every several [m]). The predetermined traveling distance may be calculated, for example, according to a distance along a road when traveling on a route. In addition, the target trajectory generating part 146 determines a target speed v and a target acceleration α for every predetermined sampling time (for example, about every several fractions of a [sec]) as a speed element of the target trajectory TR. In addition, the trajectory point may be a position at which the host vehicle M is to arrive in a sampling time for every predetermined sampling time. In this case, the target speed v or the target acceleration a is determined according to an interval of the sampling times and the trajectory points.

For example, the target trajectory generating part 146 reads the trajectory generating model data 184 from the storage 180, and generates one or a plurality of target trajectories TR using a model defined by the data. Then, the target trajectory generating part 146 selects one of the target trajectory TR among the generated one or the plurality of target trajectories TR in accordance with the degree of difficulty of environment recognition determined by the difficulty determining part 135.

The trajectory generating model data 184 is information (a program or a data structure) that defines a plurality of trajectory generating models MDL2 used to generate the target trajectory TR. The plurality of trajectory generating models MDL2 include the trajectory generating models MDL2 implemented by the rule base, and the trajectory generating models MDL2 implemented by the DNN. Hereinafter, the trajectory generating model MDL2 implemented by the rule base is referred to as “a rule based model MDL2-1” and the trajectory generating model MDL2 implemented by the DNN is referred to as “a DNN model MDL2-2” and described. The rule based model MDL2-1 is an example of “a first model” and the DNN model MDL2-2 is an example of “a second model.”

The rule based model MDL2-1 is a model of deriving the target trajectory TR from the risk region RA on the basis of a rule group previously determined by an expert or the like. Such a rule based model MDL2-1 is also referred to as an expert system because the rule group is determined by an expert or the like. The rule group includes a law such as a road traffic law or the like, regulations, practices, or the like.

For example, in the rule group, a rule to which a target trajectory TRx is uniquely associated in a certain condition X may exist. The condition X is, for example, the risk region RA input to the rule based model MDL2-1 is same as the risk region RA_{X} that can be generated when the host vehicle M is traveling on a road having one lane on each side and a preceding vehicle with a speed of XX [km/h] is present within a predetermined distance in front of the host vehicle M. The target trajectory TRx is, for example, the target trajectory TR in which a target speed is ν_{X}, a target acceleration is α_{X}, a displacement amount of steering is u_{X}, and a curvature of the trajectory is κ_{X}. According to such a rule, the rule based model MDL2-1 outputs the target trajectory TRx when the risk region RA that satisfies the condition X is input.

Although experts and others determine the rule group, it is rare that all kinds of rules are comprehensively determined. For this reason, it is also assumed that the host vehicle M is not present in the rule group (a circumstance not expected by the experts), and in some cases, the risk region RA that does not correspond to the rule group is entered to the rule based model MDL2-1. In this case, the rule based model MDL2-1 does not output the target trajectory TR. Instead of this, when the risk region RA that does not correspond to the rule group is input, the rule based model MDL2-1 may output the previously determined target trajectory TR that does not depend on the risk region RA in a current status such as traveling the current lane at a previously determined speed. That is, when the risk region RA that is not expected in advance is input, the rule group may include a general rule corresponding to an irregular circumstance such as outputting the previously determined target trajectory TR that does not depend on the risk region RA in the current status.

The DNN model MDL2-2 is a model learned to output the target trajectory TR when the risk region RA is input. Specifically, the DNN model MDL2-2 may be a CNN, an RNN, or a combination of these. The trajectory generating model data 184 includes, for example, various types of information such as the above-mentioned coupling information, coupling coefficient, or the like.

For example, the DNN model MDL2-2 is sufficiently learned on the basis of the instructor data. The instructor data is, for example, a data set in which the target trajectory TR, which is a correct answer that the DNN model MDL2-2 should output, is associated with the risk region RA as an instructor label (also referred to as a target). That is, the instructor data is a data set in which the risk region RA that is input data and the target trajectory TR that is output data are combined. The target trajectory TR, which is the correct answer, may be, for example, the target trajectory that passes the mesh having the lowest risk potential p, which is less than the threshold Th, among the plurality of meshes contained in the risk region RA. In addition, the target trajectory TR, which is the correct answer, may be, for example, an actual trajectory of a vehicle driven by a driver in a certain risk region RA.

The target trajectory generating part 146 inputs the risk region RA calculated by the risk region calculating part 144 to each of the rule based model MDL2-1 and the DNN model MDL2-2, and generates the target trajectory TR on the basis of the output result of each of the models MDL to which the risk region RA is input.

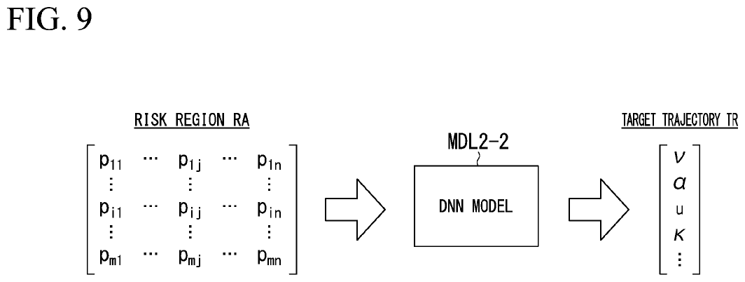

FIG. 9 is a view schematically showing a method of generating the target trajectory TR. For example, the target trajectory generating part 146 inputs a vector or a tensor representing the risk region RA to the DNN model MDL2-2. In the example shown, the risk region RA is represented as a second-order tensor with m rows and n columns. The DNN model MDL2-2 to which the vector or the tensor representing the risk region RA is input outputs the target trajectory TR. The target trajectory TR is represented by, for example, a vector or a tensor including a plurality of elements such as a target speed ν, a target acceleration α, a displacement amount u of steering, and a curvature κ of a trajectory.

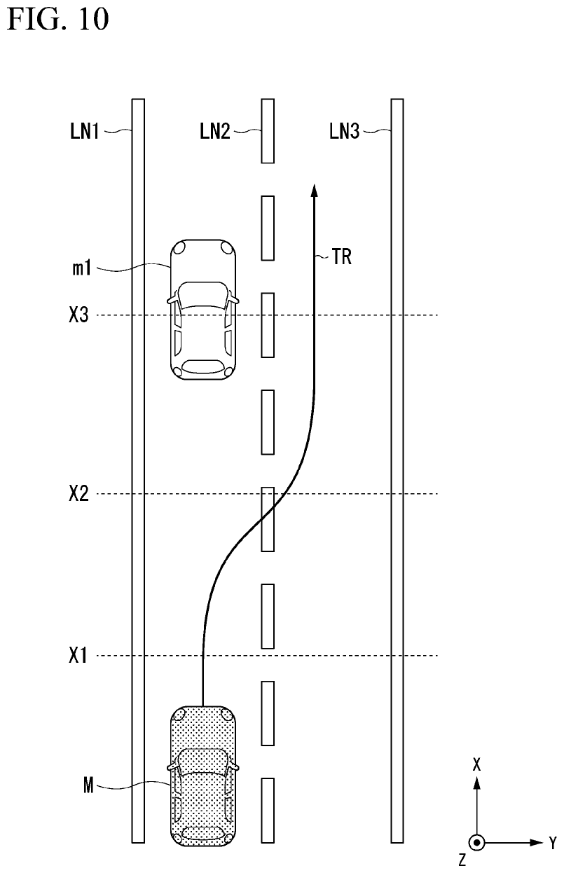

FIG. 10 is a view showing an example of the target trajectory TR output by the trajectory generating models MDL2. Like the example shown, since the risk potential p around the preceding vehicle m1 is increased, the target trajectory TR is generated to avoid it. As a result, the host vehicle M changes the lane to a neighboring lane partitioned by road marking lines LN2 and LN3, and overtakes the preceding vehicle m1.

Returning to the description of FIG. 2, the second controller 160 controls the traveling driving power output device 200, the brake device 210, and the steering device 220 such that the host vehicle M passes through the target trajectory TR generated by the target trajectory generating part 146 on time. The second controller 160 includes, for example, a first acquisition part 162, a speed controller 164 and a steering controller 166. The second controller 160 is an example of “a driving controller.”

The first acquisition part 162 acquires the target trajectory TR from the target trajectory generating part 146, and stores the acquired target trajectory TR in a memory of the storage 180.

The speed controller 164 controls one or both of the traveling driving power output device 200 and the brake device 210 on the basis of the speed element (for example, the target speed ν, the target acceleration α, or the like) included in the target trajectory TR stored in the memory.

The steering controller 166 controls the steering device 220 according to the position element included in the target trajectory stored in the memory (for example, a curvature κ of the target trajectory, a displacement amount u of the steering according to the position of the trajectory point, or the like).

Processing of the speed controller 164 and the steering controller 166 is realized by, for example, a combination of feedforward control and feedback control. As an example, the steering controller 166 combines and executes the feedforward control according to the curvature of the road in front of the host vehicle M and the feedback control on the basis of the separation from the target trajectory TR.

The traveling driving power output device 200 outputs a traveling driving power (torque) to a driving wheel in order to cause the vehicle to travel. The traveling driving power output device 200 includes, for example, a combination of an internal combustion engine, an electric motor, and a gearbox, and a power electronic control unit (ECU) configured to control them. The power ECU controls the configuration according to the information input from the second controller 160 or the information input from the driving operator 80.

The brake device 210 includes, for example, a brake caliper, a cylinder configured to transmit a hydraulic pressure to the brake caliper, an electric motor configured to generate a hydraulic pressure in the cylinder, and a brake ECU. The brake ECU controls the electric motor according to the information input from the second controller 160 or the information input from the driving operator 80 such that a brake torque according to the braking operation is output to the wheels. The brake device 210 may include a mechanism configured to transmit a hydraulic pressure generated by an operation of the brake pedal included in the driving operator 80 to the cylinder via the master cylinder as a backup. Further, the brake device 210 is not limited to the above-mentioned configuration and may be an electronically controlled hydraulic brake device configured to control an actuator according to the information input from the second controller 160 and transmit a hydraulic pressure of the master cylinder to the cylinder.

The steering device 220 includes, for example, a steering ECU and an electric motor. The electric motor changes an orientation of a steered wheel by, for example, applying a force to a rack and pinion mechanism. A steering ECU drives the electric motor and changes an orientation of the steered wheel according to the information input from the second controller 160 or the information input from the driving operator 80.

### [Processing Flow]

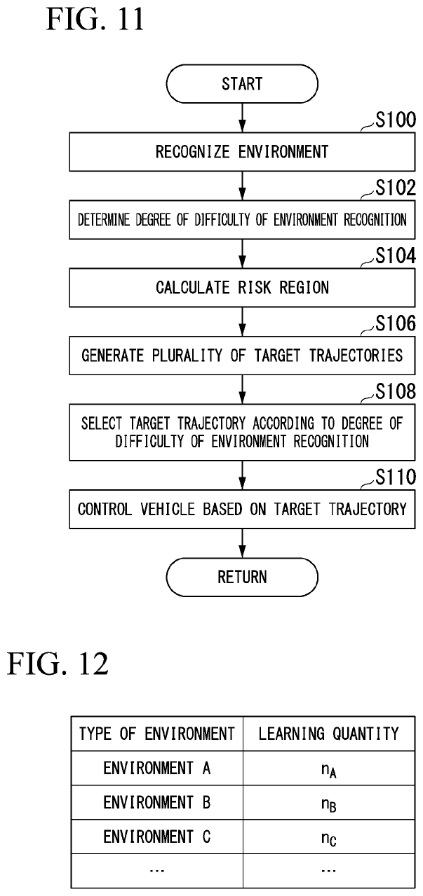

Hereinafter, a series of processing flows of the automatic driving control device 100 according to the first embodiment will be described using a flowchart. FIG. 11 is a flowchart showing an example of a series of processing flows by the automatic driving control device 100 according to the first embodiment. Processing of the flowchart may be repeatedly performed at predetermined time intervals, for example.

First, the recognition part 130 recognizes an environment around the host vehicle M (step S100). For example, the recognition part 130 may recognize a type or a state of an object using the environment recognition model MDL1.

Next, the difficulty determining part 135 determines a degree of difficulty of environment recognition on the basis of an environment around the host vehicle M recognized by the recognition part 130 (step S102). The environment disclosed herein may be various environments such as city areas, suburbs, bad weather, good weather, nighttime, daytime, general roads, expressways, and the like.

For example, the difficulty determining part 135 increases the degree of difficulty of environment recognition in a case in which the environment around the host vehicle M recognized by the recognition part 130 is a city area in comparison with a case in which the environment around the host vehicle M recognized by the recognition part 130 is a suburb. In other words, the difficulty determining part 135 makes a degree of difficulty of environment recognition higher in a case in which the host vehicle M is traveling in a city area than in a case in which the host vehicle M is traveling in a suburb.

In addition, for example, the difficulty determining part 135 increases a degree of difficulty of environment recognition in a case in which the environment around the host vehicle M recognized by the recognition part 130 is bad weather in comparison with a case in which the environment around the host vehicle M recognized by the recognition part 130 is good weather. In other words, the difficulty determining part 135 increases a degree of difficulty of environment recognition in a case in which the host vehicle M is traveling in bad weather in comparison with a case in which the host vehicle M is traveling in good weather.

In addition, for example, the difficulty determining part 135 increases a degree of difficulty of environment recognition in a case in which the environment around the host vehicle M recognized by the recognition part 130 is during the nighttime in comparison with a case in which the environment around the host vehicle M recognized by the recognition part 130 is during the daytime. In other words, the difficulty determining part 135 increases a degree of difficulty of environment recognition in a case in which the host vehicle M is traveling at nighttime in comparison with a case in which the host vehicle M is traveling at daytime.

In addition, for example, the difficulty determining part 135 increases a degree of difficulty of environment recognition in a case in which the environment around the host vehicle M recognized by the recognition part 130 is a general road in comparison with a case in which the environment around the host vehicle M recognized by the recognition part 130 is an expressway. In other words, the difficulty determining part 135 increases a degree of difficulty of environment recognition in a case in which the host vehicle M is traveling on a general road in comparison with a case in which the host vehicle M is traveling on an expressway.

In addition, the difficulty determining part 135 may determine a degree of difficulty of environment recognition according to a learning quantity n of the environment recognition model MDL1 used when the recognition part 130 recognizes the environment around the host vehicle M. The learning quantity n of the environment recognition model MDL1 is previously stored in the storage 180 as the learning quantity data 186.

FIG. 12 is a view showing an example of the learning quantity data 186. As in the example shown, the learning quantity data 186 is data in which the learning quantity n of the environment recognition model MDL1 corresponds to each of a plurality of environments that are different from each other.

For example, the environment recognition model MDL1 is learned repeatedly n_{A} times using n_{A} pieces of instructor data obtained under a certain environment A. That is, the environment recognition model MDL1 is learned repeatedly n_{A} times to output information showing the environment A as the environment around the target vehicle when sensing results from around the target vehicle under the environment A are input. In this case, in the learning quantity data 186, the learning quantity n_{A} is associated with the environment A.

Similarly, the environment recognition model MDL1 is learned repeatedly n_{B} times using n_{B} pieces of instructor data obtained under a certain environment B. That is, the environment recognition model MDL1 is learned repeatedly n_{B} times to output information showing the environment B as the environment around target vehicle when the sensing result around the target vehicle under the environment B is input. In this case, in the learning quantity data 186, the learning quantity n_{B} is associated with the environment B.

For example, the difficulty determining part 135 determines a degree of difficulty of environment recognition according to the learning quantity n_{A} associated with the environment A in the learning quantity data 186 when the environment around the host vehicle M recognized by the recognition part 130 is the environment A. In addition, the difficulty determining part 135 determines a degree of difficulty of environment recognition according to the learning quantity nB associated with the environment B in the learning quantity data 186 when the environment around the host vehicle M recognized by the recognition part 130 is the environment B.

The difficulty determining part 135 may decrease a degree of difficulty of environment recognition as the learning quantity n of the environment recognition model MDL1 gets larger, and may increase a degree of difficulty of environment recognition as the learning quantity n of the environment recognition model MDL1 gets smaller. Accordingly, for example, when the learning quantity n_{B} is smaller than the learning quantity n_{A}, the degree of difficulty of environment recognition of the environment B is higher in comparison with the environment A.

In addition, the difficulty determining part 135 may determine a degree of difficulty of environment recognition according to the number of moving body (for example, other vehicles, pedestrians, bicycles, and the like) around the host vehicle M recognized as a part of the environment by the recognition part 130. Specifically, the difficulty determining part 135 may decrease a degree of difficulty of environment recognition as the number of moving body gets smaller and may increase a degree of difficulty of environment recognition as the number of moving body gets larger.

In addition, the difficulty determining part 135 may determine a degree of difficulty of environment recognition according to a curvature of a road recognized as a part of the environment by the recognition part 130. Specifically, the difficulty determining part 135 may decrease a degree of difficulty of environment recognition as a curvature of the road is smaller and may increase a degree of difficulty of environment recognition as the curvature of the road is larger.

In addition, the difficulty determining part 135 may determine a degree of difficulty of environment recognition according to a relative speed difference between an average speed of a plurality of moving bodies recognized as a part of the environment by the recognition part 130 and a speed of the host vehicle M. For example, it is assumed that the recognition part 130 has recognized that three other vehicles are present around the host vehicle M. In this case, the difficulty determining part 135 calculates an average speed of the three other vehicles, and calculates the speed difference between the average speed and the host vehicle M. For example, the difficulty determining part 135 may decrease a degree of difficulty of environment recognition as the speed difference is decreased and may increase a degree of difficulty of environment recognition as the speed difference is increased. Accordingly, when other vehicles in the vicinity are significantly faster or slower than the host vehicle M, a degree of difficulty of environment recognition is increased, and when speeds of the host vehicle M and other vehicles in the vicinity are substantially equal to each other, a degree of difficulty of environment recognition is decreased.

In addition, the difficulty determining part 135 may determine a degree of difficulty of environment recognition according to a speed of the host vehicle M (an absolute speed). Specifically, the difficulty determining part 135 may decrease a degree of difficulty of environment recognition as the speed of the host vehicle M is increased, or may increase a degree of difficulty of environment recognition as the speed of the host vehicle M is decreased.

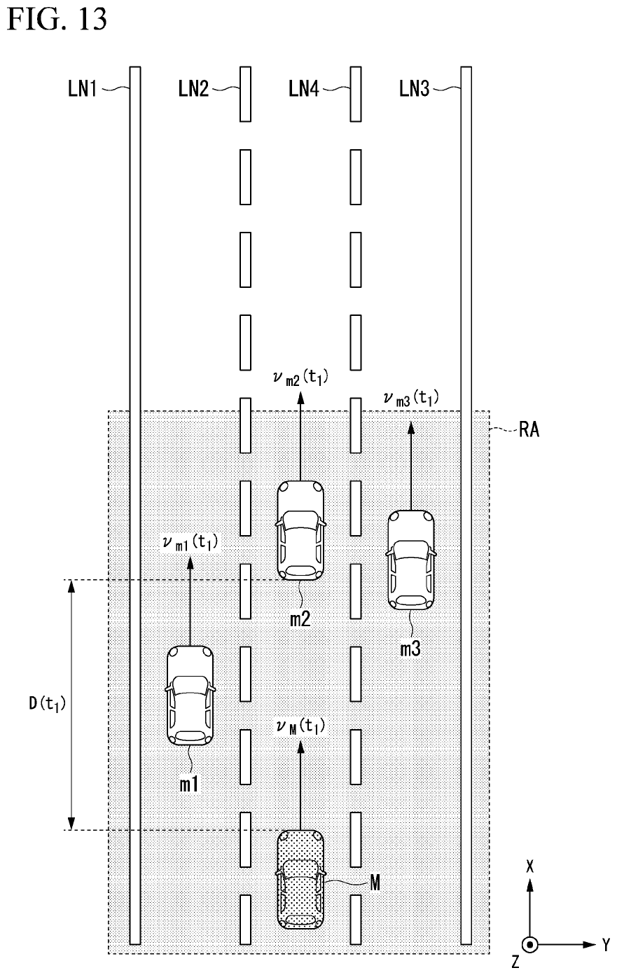

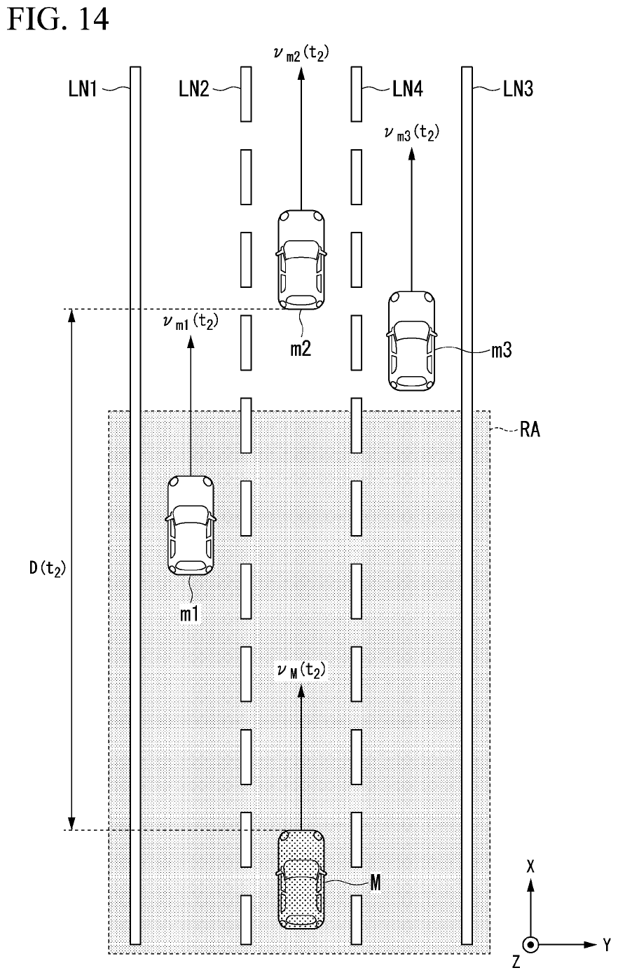

FIG. 13 is a view showing an example of a situation in a certain first time period t₁. FIG. 14 is a view showing an example of a situation in a second time period t₂. In the situations exemplified in FIG. 13 and FIG. 14, three other vehicles m1 to m3 are present.

At the first time period t₁, a speed of the host vehicle M is ν_{M}(t₁), a speed of the other vehicle m1 is νₘ₁(t₁), a speed of the other vehicle m2 is νₘ₂(t₁), and a speed of the other vehicle m3 is νₘ₃(t₁). In addition, an inter-vehicle distance between the host vehicle M and the other vehicle m2 that is a preceding vehicle with respect to the host vehicle M is D(t₁).

Meanwhile, at the second time period t₂, a speed of the host vehicle M is ν_{M}(t₂) that is greater than a speed ν_{M}(t₁) at the first time period t₁. A speed of the other vehicle m1 is νₘ₁(t₂) that is greater than a speed νₘ₁(t₁) in the first time period t₁. A speed of the other vehicle m2 is νₘ₂(t₂) that is greater than a speed νₘ₂(t₁) in the first time period t₁. A speed of the other vehicle m3 is νₘ₃(t₂) that is greater than a speed vₘ₃(t₁) in the first time period t₁. Under such speed conditions, an inter-vehicle distance D(t₂) between the other vehicle m2 and the host vehicle M in the second time period t₂ is likely to be greater than an inter-vehicle distance D(t₁) in the first time period t₁.

In general, a speed of the other vehicle around the host vehicle M also increases as the speed of the host vehicle M increases, and the inter-vehicle distance between these vehicles inevitably tends to be increased in consideration of safety. This means that the number of moving bodies present in the risk region R is reduced. That is, as the speed of the host vehicle M is increased, the number of target objects which will be used to calculate the risk potential p by the risk region calculating part 144 is reduced. While the calculation target of the risk potential p is the three other vehicles m1 to m3 in the situation of FIG. 13, a calculation target of the risk potential p is only one other vehicle m1 in a situation of FIG. 14 in which a speed of the host vehicle M is greater than that in the situation of FIG. 13.

Since the traffic circumstances around the host vehicle M is simplified as the number of objects that are calculation targets of the risk potential p decreases, it becomes easier to match with the rule group defined by the rule based model MDL2-1, and the target trajectory TR output by the rule based model MDL2-1 becomes a highly accurate trajectory that is more suitable for the surrounding environment of the host vehicle M.

The difficulty determining part 135 may obtain a weighted sum (a linear sum) of degrees of difficulty of environment recognition determined based on the above-mentioned various elements. For example, the difficulty determining part 135 may set a weighted sum of a total of eight degrees of difficulty, for example, (1) a degree of difficulty according to a city area or a suburb, (2) a degree of difficulty according to bad weather or good weather, (3) a degree of difficulty according to nighttime or daytime, (4) a degree of difficulty according to a general road or an expressway, (5) a degree of difficulty according to the learning quantity n of the environment recognition model MDL1, (6) a degree of difficulty according to the number of moving bodies around the host vehicle M, (7) a degree of difficulty according to a relative speed difference between an average speed of a plurality of moving bodies and a speed of the host vehicle M, and (8) a degree of difficulty according to the speed of the host vehicle M, as a final degree of difficulty of environment recognition.

Returning to description of the flowchart of FIG. 11, next, the risk region calculating part 144 calculates the risk region RA on the basis of a type or a state of the object recognized as a part of the environment by the recognition part 130 (step S104).

For example, the risk region calculating part 144 may divide a range previously determined with reference to the host vehicle M into a plurality of mesh squares, and calculate the risk potential p with respect to each of the plurality of mesh squares. Then, the risk region calculating part 144 calculates a vector or a tensor in which the risk potential p corresponds to each of the mesh squares as the risk region RA. Here, the risk region calculating part 144 normalizes the risk potential p.

Next, the target trajectory generating part 146 inputs the risk region RA calculated by the risk region calculating part 144 to each of the rule based model MDL2-1 and the DNN model MDL2-2, and generates the plurality of target trajectories TR on the basis of the output results of the models MDL to which the risk region RA is input (step S106).

Next, the target trajectory generating part 146 selects one target trajectory TR from the plurality of target trajectories TR in accordance with the degree of difficulty of environment recognition determined by the difficulty determining part 135 (step S108).

For example, a degree of difficulty of environment recognition may be represented using a numerical range of 0 to 1, and the degree of difficulty may decrease as the number approaches 0, and the degree of difficulty may increase as the number approaches 1. In this case, the target trajectory generating part 146 selects the target trajectory TR output by the rule based model MDL2-1 (hereinafter, referred to as a first target trajectory TR1) from the plurality of target trajectories TR when the degree of difficulty of environment recognition is equal to or smaller than a predetermined value (when environment recognition is easy). Meanwhile, the target trajectory generating part 146 selects the target trajectory TR output by the DNN model MDL2-2 (hereinafter, referred to as a second target trajectory TR2) from the plurality of target trajectories TR when the degree of difficulty of environment recognition exceeds the predetermined value (when the environment recognition is difficult). The predetermined value may be, for example, about 0.5.

Accordingly, the first target trajectory TR1 is likely to be selected when the degree of difficulty of environment recognition is low and a traffic circumstance around the host vehicle M is relatively simple, and the second target trajectory TR2 is likely to be selected when the degree of difficulty of environment recognition is high and the traffic circumstance around the host vehicle M is complicated.

When either the first target trajectory TR1 or the second target trajectory TR2 is selected from the plurality of target trajectories TR, the target trajectory generating part 146 outputs the selected target trajectory TR to the second controller 160. In response, the second controller 160 controls at least one of the speed and the steering of the host vehicle M on the basis of the target trajectory TR output by the target trajectory generating part 146 (step S110). Accordingly, processing of the flowchart is terminated.

According to the above-mentioned first embodiment, the automatic driving control device 100 recognizes the environment around the host vehicle M using the environment recognition model MDL1 that was previously learned. The automatic driving control device 100 determines a degree of difficulty of environment recognition on the basis of the environment around the recognized host vehicle M. In addition, the automatic driving control device 100 generates a plurality of target trajectories TR using both of the rule based model MDL2-1 and the DNN model MDL2-2 on the basis of the environment around the recognized host vehicle M. The automatic driving control device 100 selects one target trajectory TR from the plurality of target trajectories TR in accordance with the degree of difficulty of environment recognition. Then, the automatic driving control device 100 automatically controls driving of the host vehicle M on the basis of the selected target trajectory TR. Accordingly, driving of the host vehicle M can be smoothly controlled.

### Second Embodiment

Hereinafter, a second embodiment will be described. The second embodiment is distinguished from the above-mentioned first embodiment in that, when the host vehicle M is in an emergency state, the first target trajectory TR1 is selected regardless of the degree of difficulty of environment recognition. Hereinafter, the differences from the first embodiment will be mainly explained, and common points with the first embodiment will be omitted. Further, in the description of the second embodiment, the same portions as those in the first embodiment are designated by the same reference signs and described.

The difficulty determining part 135 according to the second embodiment further determines whether the host vehicle M is in an emergency state, in addition to determination of the degree of difficulty of environment recognition. The emergency state is, for example, a state in which a risk to avoid is imminent for the host vehicle M. Specifically, the emergency state is a state in which a pedestrian or a bicycle jumps out onto the roadway, or a state in which a preceding vehicle suddenly slows down.

For example, the difficulty determining part 135 may determine whether the host vehicle M is in an emergency state on the basis of a TTC between the moving body (a pedestrian, a preceding vehicle, or the like) recognized as a part of the environment by the recognition part 130 and the host vehicle M. The TTC is obtained by dividing the relative distance between the moving body and the host vehicle M by the relative speed between the moving body and the host vehicle M. For example, the difficulty determining part 135 may determine that the host vehicle M is not in the emergency state when the TTC is equal to or greater than a threshold T_{Th}, and determine that the host vehicle M is in the emergency state when the TTC is less than the threshold T_{Th}.

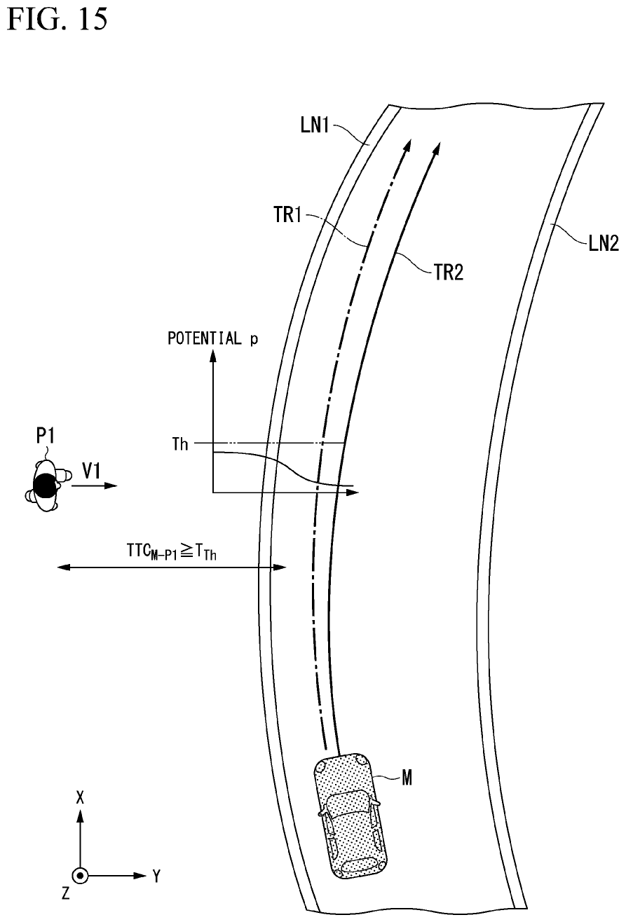

FIG. 15 is a view showing an example of a situation that the host vehicle M may encounter. P1 in the drawing represents a pedestrian, and V1 represents a moving direction of the pedestrian P1. In the situation shown, TTC_{M-P1} between the pedestrian P1 and the host vehicle M is equal to or greater than the threshold T_{Th}. In this case, the difficulty determining part 135 determines that the host vehicle M is not in the emergency state.

Meanwhile, in the situation shown, the risk potential p of the region close to the pedestrian P1 is less than the threshold Th. In this case, the rule based model MDL2-1 outputs the trajectory passing through the region close to the left of the lane center as the first target trajectory TR1 on the lane partitioned by the roadway edge marking LN1 and LN2 so as to follow a rule such as “a keep left” . Since the DNN model MDL2-2 learns a tendency of manual driving of a driver, like the first target trajectory TR1, it is likely to output the trajectory passing through the region close to the left of the lane center as the second target trajectory TR2.

In the situation shown, it is determined that the host vehicle M is not in the emergency state. In this case, the target trajectory generating part 146 according to the second embodiment selects either the first target trajectory TR1 or the second target trajectory TR2 according to the degree of difficulty of environment recognition. In the situation shown, the degree of difficulty of environment recognition is high because the curvature of the road is great. Accordingly, the second target trajectory TR2 is selected, and driving of the host vehicle M is controlled on the basis of the second target trajectory TR2.

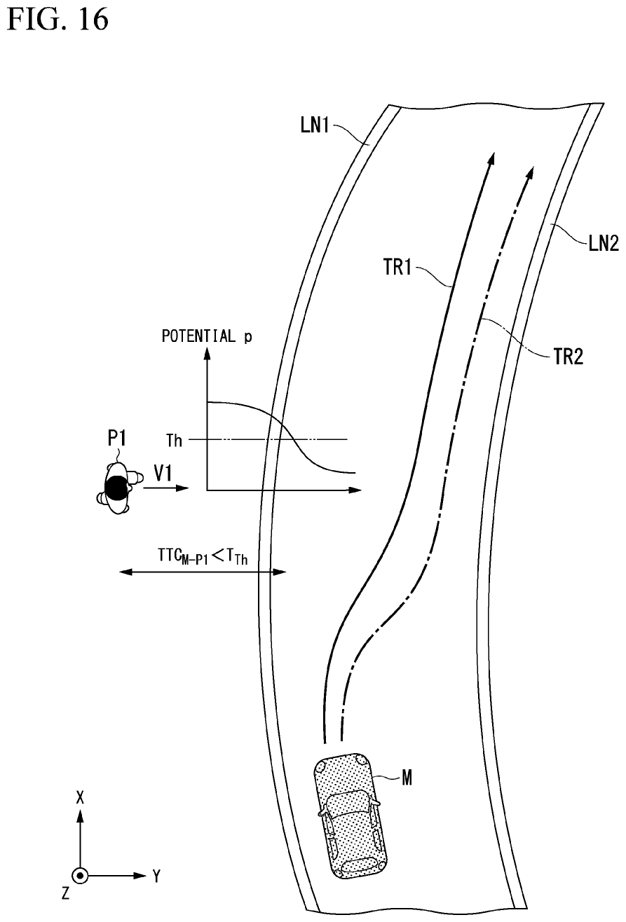

FIG. 16 is a view showing another example of a situation that the host vehicle M may encounter. In the situation of FIG. 16, since the pedestrian P1 is closer to the roadway than the situation of FIG. 15 and there is a risk of jumping out, the TTC_{M-P1} between the pedestrian P1 and the host vehicle M is less than the threshold T_{Th}. In this case, the difficulty determining part 135 determines that the host vehicle M is in an emergency state.

Meanwhile, in the situation shown, the risk potential p of the region close to the pedestrian P1 is equal to or greater than the threshold Th. In this case, the rule based model MDL2-1 outputs the trajectory passing through the region closer to the right of the lane center as the first target trajectory TR1 so as to follow a rule that the relative distance to an obstacle should be maintained equal to or greater than a certain level. Since the DNN model MDL2-2 learns a tendency of manual driving of the driver such as avoiding an obstacle, like the first target trajectory TR1, it is likely to output the trajectory passing through the region close to the right of the lane center (a region having a lower risk potential p) as the second target trajectory TR2.

In the situation shown, it is determined that the host vehicle M is in an emergency state. In this case, the target trajectory generating part 146 according to the second embodiment selects the first target trajectory TR1 in which safer driving control can be expected regardless of the degree of difficulty of environment recognition. Accordingly, since driving of the host vehicle M is controlled so as to avoid the pedestrian P1, it is possible to control driving of the host vehicle M more safely.

According to the above-mentioned second embodiment, the automatic driving control device 100 determines whether the host vehicle M is in an emergency state, selects the first target trajectory TR1 regardless of the degree of difficulty of environment recognition when it is determined that the host vehicle M is in the emergency state, and controls driving of the host vehicle M so as to avoid the moving body such as a pedestrian or the like on the basis of the first target trajectory TR1. Accordingly, it is possible to control driving of the host vehicle M more safely.

### Other Embodiments (Variants)

Hereinafter, other embodiments (variants) will be described. In the above-mentioned first or second embodiment, while the target trajectory generating part 146 has been described as inputting the risk region RA calculated by the risk region calculating part 144 to each of the rule based model MDL2-1 and the DNN model MDL2-2 and generating the plurality of target trajectories TR on the basis of the output result of each of the models MDL to which the risk region RA is input, it is not limited thereto.

For example, the target trajectory generating part 146 may generate the target trajectory TR using a model created based on a method referred to as a model based or a model based design (hereinafter, referred to as a model based model), instead of or in addition to the rule based model MDL2-1. The model based model is a model of determining (or outputting) the target trajectory TR according to the risk region RA using an optimization method such as model predictive control (MPC) or the like. The model based model is another example of “a first model.”

In addition, for example, the target trajectory generating part 146 may generate the target trajectory TR through a model using another machine learning as a base, for example, a binary tree type model, a game tree type model, a model in which bottom layer neural networks are coupled to each other like a Boltzmann machine, a reinforcement learning model, or a deep reinforcement learning model as a base, instead of or in addition to the DNN model MDL2-2. The binary tree type model, the game tree type model, the model in which bottom layer neural networks are coupled to each other like a Boltzmann machine, the reinforcement learning model, the deep reinforcement learning model, or the like, is another example of “a second model.”

### [Hardware Configuration]

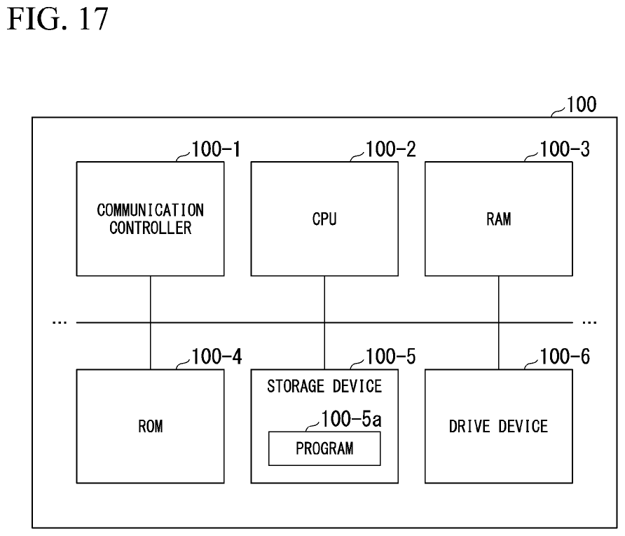

FIG. 17 is a view showing an example of a hardware configuration of the automatic driving control device 100 of the embodiment. As shown, the automatic driving control device 100 has a configuration in which a communication controller 100-1, a CPU 100-2, a RAM 100-3 used as a working memory, a ROM 100-4 configured to store a booting program or the like, a storage device 100-5 such as a flash memory, an HDD, or the like, a drive device 100-6, and the like, are connected to each other by an internal bus or a dedicated communication line. The communication controller 100-1 performs communication with components other than the automatic driving control device 100. A program 100-5a executed by the CPU 100-2 is stored in the storage device 100-5. The program is developed in the RAM 100-3 by a direct memory access (DMA) controller (not shown) or the like, and executed by the CPU 100-2. Accordingly, some or all of the first controller and the second controller 160 are realized.

The above-mentioned embodiment can be expressed as follows.

A vehicle control device is configured to include:

at least one memory in which a program is stored; and

at least one processor,

wherein the processor executes the program to:

recognize an environment around a vehicle:

determine a degree of difficulty of a recognition of the environment on the basis of the recognized environment:

generate a plurality of target trajectories along which the vehicle is to travel on the basis of the recognized environment and select one target trajectory from the generated plurality of target trajectories in accordance with the determined degree of difficulty: and

automatically control driving of the vehicle on the basis of the selected target trajectory.

While preferred embodiments of the invention have been described and illustrated above, it should be understood that these are exemplary of the invention and are not to be considered as limiting. Additions, omissions, substitutions, and other modifications can be made without departing from the scope of the present invention. Accordingly, the invention is not to be considered as being limited by the foregoing description, and is only limited by the scope of the appended claims.

What is claimed is:

1. A vehicle control method, comprising:
recognizing an environment around the vehicle;
determining a degree of difficulty of a recognition of the environment on the basis of the recognized environment;
generating a plurality of target trajectories along which the vehicle is to travel on the basis of the recognized environment and selecting one target trajectory from the generated plurality of target trajectories in accordance with the determined degree of difficulty; and
automatically controlling driving of the vehicle on the basis of the selected target trajectory.

2. The vehicle control method according to claim 1, further comprising:
calculating a region of risk distributed around an object as a part of the environment, and
inputting the region to each of a plurality of models that outputs the target trajectory when the region is input, and generating the plurality of target trajectories on the basis of an output result of each of the plurality of models into which the region was input.

3. The vehicle control method according to claim 2, wherein the plurality of models include a first model which is rule-based model or model-based model, and a second model which is a machine learning based model.

4. The vehicle control method according to claim 3, wherein, among a first target trajectory that is the target trajectory output by the first model and a second target trajectory that is the target trajectory output by the second model, the second target trajectory is selected in a case the degree of difficulty exceeds a predetermined value.

5. The vehicle control method according to claim 1, further comprising:
sensing surroundings of the vehicle, and
inputting a sensing result of surroundings of a certain target vehicle with respect to a machine learning-based third model when the sensing result is input, and recognizing the environment around the vehicle on the basis of an output result of the third model to which the sensing result was input, the machine learning-based third model being learned so as to output information showing an environment around the target vehicle.

6. The vehicle control method according to claim 5, further comprising:
determining the degree of difficulty according to a learning quantity of the third model.

7. The vehicle control method according to claim 6, wherein the third model is learned to output information showing that the environment around the target vehicle is in a certain first environment when a sensing result of surroundings of the target vehicle under the first environment is input, and is learned to output information showing that the environment around the target vehicle is in a second environment different from the first environment when a sensing result of surroundings of the target vehicle under the second environment is input, and
the vehicle control model further comprises:
determining the degree of difficulty according to the learning quantity of the third model learned under the first environment when the first environment is recognized, and determining the degree of difficulty according to the learning quantity of the third model learned under the second environment when the second environment is recognized.

8. The vehicle control method according to claim 6, further comprising:
decreasing the degree of difficulty as the learning quantity of the third model is larger, and increasing the degree of difficulty as the learning quantity of the third model is smaller.

9. The vehicle control method according to claim 1, further comprising:
determining the degree of difficulty according to a number of moving body recognized as a part of the environment.

10. The vehicle control method according to claim 9, further comprising:
decreasing the degree of difficulty as the number of the moving body is smaller, and increasing the degree of difficulty as the number of the moving body is larger.

11. The vehicle control method according to claim 1, further comprising:
determining the degree of difficulty according to a curvature of a road recognized as a part of the environment.

12. The vehicle control method according to claim 11, further comprising:
decreasing the degree of difficulty as the curvature of the road is smaller, and increasing the degree of difficulty as the curvature of the road is larger.

13. The vehicle control method according to claim 1, further comprising:
determining the degree of difficulty according to a relative speed difference between an average speed of a plurality of moving bodies recognized as a part of the environment and a speed of the vehicle.

14. The vehicle control method according to claim 13, further comprising:
decreasing the degree of difficulty as the speed difference is smaller, and increasing the degree of difficulty as the speed difference is larger.

15. The vehicle control method according to claim 1, further comprising:
determining the degree of difficulty according to a speed of the vehicle.

16. The vehicle control method according to claim 15, further comprising:
decreasing the degree of difficulty as the speed is increased, and increasing the degree of difficulty as the speed is decreased.

17. The vehicle control method according to claim 4, further comprising:
determining whether the vehicle is in an emergency state on the basis of a relative distance and a relative speed between a moving body, which is recognized as a part of the environment, and the vehicle,
selecting the first target trajectory regardless of the degree of difficulty in a case the vehicle is determined to be in the emergency state, and
controlling the driving of the vehicle such that the moving body is avoided on the basis of the selected first target trajectory.

18. A vehicle control device comprising:
a recognition part configured to recognize an environment around a vehicle;
a determining part configured to determine a degree of difficulty of a recognition of the environment on the basis of the environment recognized by the recognition part;
a generating part configured to generate a plurality of target trajectories along which the vehicle is to travel on the basis of the environment recognized by the recognition part and to select one target trajectory from the generated plurality of target trajectories in accordance with the degree of difficulty determined by the determining part; and
a driving controller configured to automatically control driving of the vehicle on the basis of the target trajectory selected by the generating part.

19. A computer-readable storage medium on which a program is stored to execute a computer mounted on a vehicle to:
recognize an environment around the vehicle;
determine a degree of difficulty of a recognition of the environment on the basis of the recognized environment;
generate a plurality of target trajectories along which the vehicle is to travel on the basis of the recognized environment and select one target trajectory from the generated plurality of target trajectories in accordance with the determined degree of difficulty; and
automatically control driving of the vehicle on the basis of the selected target trajectory.
